(19) United States
(12) Patent Application Publication
(10) Pub. No.: US 2024/0060346 A1
(43) Pub. Date: Feb. 22, 2024

(54) DEVICE AND METHOD FOR THE DETECTION OF AN ENTRAPMENT SITUATION AT A MEANS OF TRANSPORT

(71) Applicant: HÜBNER GmbH & Co. KG, Kassel (DE)

(72) Inventors: Martin Breuninger, Neu-Ulm (DE); Marcel Burhenn, Großalmerode (DE); Laurin Weitzel, Kassel (DE)

(21) Appl. No.: 18/365,670

(22) Filed: Aug. 4, 2023

(30) Foreign Application Priority Data
Aug. 19, 2022 (EP) 22191208.2

(51) Int. Cl. E05F 15/43

(52) U.S. Cl. CPC E05F 15/43; E05Y 2900/506; E05F 2015/432

(57) ABSTRACT

A device for the detection of an entrapment situation by a means of transport includes: a flexible element that encompasses a hollow space; an ultrasonic transmitter that is arranged at or inside the hollow space, the ultrasonic transmitter being set up to emit ultrasound into the hollow space; a reflector that is arranged at or inside the hollow space, the reflector being set up to reflect ultrasound; an ultrasonic detector that is arranged at or inside the hollow space, the ultrasonic detector being set up to detect the ultrasound emitted by the ultrasonic transmitter and reflected in the device, and to generate a detection signal; and a processor module that is set up to determine, based on the detection signal of the ultrasonic detector, whether there is a deformation of the flexible element which indicates that the flexible element entraps an object which is causing the deformation.

### CROSS-REFERENCE TO RELATED APPLICATIONS

This application claims priority to European Patent Application 22191208.2, filed Aug. 19, 2022, which is hereby incorporated by reference in its entirety.

### FIELD OF THE INVENTION

This disclosure concerns a device for the detection of an entrapment situation at a means of transport, a door for a means of transport having such device, a means of transport having such door, a method for the detection of an entrapment situation at a means of transport, and a storage medium for carrying out the method. This disclosure in particular concerns a detection of an entrapment situation at a means of transport by means of ultrasound in a hollow conductor.

### BACKGROUND OF THE INVENTION

Means of transport, such as buses and railroad vehicles, have automatic doors which, e.g., are opened and closed at stops. The doors usually have profiled rubber strips which in closed condition form a sealing between the door and a frame or a second door. Due to the increased requirements on means of transport and due to stricter safety regulations, profiled rubber strips often also have one or multiple signal generator functions in addition to their sealing function. For example, contact elements are integrated in many profiled rubber strips, which indicate contact with a thing or a person, and, if need be, interrupt or stop a movement of the door of the means of transport to prevent damage to the object or injury to the person.

Conventional signal generator functions often use switching strips or airwave switches. However, switching strips require a rubber compound with conductive layers and electrodes in a hollow chamber of the profiled rubber strips. However, this is elaborate and expensive to produce. Airwave switches are sensitive to leakage, humidity, and moisture, so that in the event of leakage, or humidity entering the hollow chamber, total failure of the airwave switches may occur which, in turn, may cause potential safety hazards. Likewise, there is the risk of impact of chemicals on the conductive rubber compounds. Such impact may likewise cause loss of function.

### SUMMARY OF THE INVENTION

One task of this disclosure is to show a device for the detection of an entrapment situation at a means of transport, a door for a means of transport having such device, a means of transport having such door, a method for the detection of an entrapment situation at a means of transport, and a storage medium for carrying out the method, which enable reliable entrapment detection. In particular, a task of this disclosure is to reduce the costs for entrapment detection and/or a probability of failure of the entrapment detection.

This task is solved by the subject-matter disclosed herein. Beneficial embodiments are also disclosed.

According to an independent aspect of this disclosure, a method for the detection of an entrapment situation at a means of transport, in particular at closable openings of the means of transport, is identified. The device comprises a flexible element that encompasses a hollow space; an ultrasonic transmitter that is arranged at or inside the hollow space, the ultrasonic transmitter being set up to emit ultrasound into the hollow space; a reflector that is arranged at or inside the hollow space, the reflector being set up to reflect ultrasound; an ultrasonic detector that is arranged at or inside the hollow space, the ultrasonic detector being set up to detect the ultrasound emitted by the ultrasonic transmitter and reflected in the device, and to generate a detection signal; and a processor module that is set up to determine, based on the detection signal of the ultrasonic detector, whether there is a deformation of the flexible element which indicates that the flexible element entraps an object (e.g., a thing or a person) which is causing the deformation.

According to the invention, ultrasound is emitted into the hollow space of the flexible element, reflected there, and detected. Based on the detected reflections of the ultrasound, it is determined whether there is a deformation of the flexible element. To this end, the reflector serves as reference, i.e., if the ultrasound passes through the hollow space without hindrance, and is reflected by the reflector back to the ultrasound detector, then there is no deformation, and hence no entrapment of an object. If the ultrasound received at the ultrasonic detector does not correspond to this reference, it can be determined, e.g., in dependence on a propagation time and/or an amplitude of the reflections received at the ultrasonic detector, how great the deformation is, and whether it can be derived from this that an object is entrapped by the flexible element. The combination of ultrasonic transmitter, reflector, and ultrasonic detector enables reliable and cost-effective entrapment detection.

The device, in particular the processor module, can output a digital signal that is output to an external unit, and indicates an entrapment. The external unit can, e.g., be a door control unit that controls an opening and closing of doors of the means of transport. Hence, the device according to the invention can be used flexibly. For example, conventional switching strip systems and airwave switches can be replaced by the device according to the invention without the need to adjust, e.g., the door control units or the on-board electronics of the means of transport.

Optionally, the device can provide additional outputs, such as tripping times (i.e., detected entrapments), error logs, a system readiness, etc. In some embodiments, the device can include an error memory for error logs, which documents the most recent events either with the time difference since occurrence, or since start of operation on a day. This can reduce the requirements on a clock in the circuit, because the drift period is shorter, and the drift is sufficiently small within a relevant period of time (e.g., until examination by an expert) even in the case of low-priced components.

Preferably, the deformation is a cross-section constriction or a contraction of the hollow space of the flexible element.

Preferably, the reflector is arranged within the hollow space. In other words, the reflector may be an internal reflector.

Preferably, the ultrasonic transmitter is set up to emit ultrasonic pulses. Each such ultrasonic pulse has a pulse width, and an amplitude which can be chosen appropriately in dependence on the device and/or an area of application of the device.

Preferably, the ultrasonic transmitter is set up to emit the ultrasonic pulses at predefined time intervals. For example, the ultrasonic pulses can be emitted at regular time intervals.

Preferably, the ultrasonic transmitter is set up to emit the ultrasonic pulses in dependence on a situation. In some embodiments, the ultrasonic pulses can be emitted in dependence on an operating state of the means of transport and/or a state of motion of the means of transport. In particular, the device for entrapment detection may be operated only while there is the danger of an object being entrapped by the flexible element. Examples of operating states in which ultrasonic pulses are emitted include a closing of an opening of the means of transport, e.g., the closing of a door of the means of transport. An example of a state of motion of the means of transport during which ultrasonic pulses are emitted is the standstill of the means of transport. A further example is the period of time after the closing of the door during the initial acceleration phase of a means of transport.

Preferably, the processor module is set up to determine, based on a propagation time of the ultrasonic pulses reflected in the device, and received at the ultrasonic detector, whether the deformation of the flexible element is present. In particular, the ultrasonic pulses can be reflected in dependence on the deformation at different locations, which results in different propagation times between the ultrasonic transmitter and the ultrasonic detector, which, in turn, give information about the deformation of the flexible element.

In addition, or alternatively, the processor module is set up to determine, based on an amplitude of the ultrasonic pulses reflected in the device, and received at the ultrasonic detector, whether the deformation of the flexible element is present. In particular, the ultrasonic pulses may be reflected in different ways in dependence on the deformation, which has an influence on the amplitude of the reflections, so that information about the deformation of the flexible element can be derived from this. Among other things, observing the amplitudes of the reflections allows a flexible adjustment of the sensitivity of the entrapment detection, e.g., by setting appropriate threshold values for the amplitudes.

Preferably, the processor module is set up to determine that an object which is causing the deformation is entrapped by the flexible element if the propagation time of a reflection of an ultrasonic pulse received at the ultrasonic detector is shorter than a reference propagation time. The reference propagation time may be a propagation time of an ultrasonic pulse between the ultrasonic transmitter and the ultrasonic detector. In other words, the reflector may provide a reference. If an ultrasonic pulse does not reach the reflector, and is reflected completely by a deformed area, the detection signal of the ultrasonic detector will indicate a (single) reflection with a shorter propagation time. This allows to infer that a large deformation of the flexible element has occurred, and to detect entrapment of an object by the flexible element.

Preferably, the processor module is set up to determine that an object which is causing the deformation is entrapped by the flexible element if the amplitude of the reflection of the ultrasonic pulse received at the ultrasonic detector with the reference propagation time is smaller than a reference amplitude. The reference amplitude may correspond to an amplitude that occurs if there is no deformation, and the ultrasonic pulse reaches the reflector without hindrance. The smaller amplitude of the ultrasonic pulse with the reference propagation time may indicate that a part of the ultrasonic pulse is reflected by a deformed area of the flexible element, but that, nevertheless, a part of the ultrasonic pulse is still reaching the reflector. This is indicative of a partial deformation of the flexible element.

Preferably, the processor module can be set up to determine, based on a deviation of the amplitude of the reflection from the reference amplitude, a degree of the deformation of the flexible element. If the deviation is small, the deformation is slight. If, however, the deviation is large, the deformation is large.

Preferably, the processor module is set up to determine that an object which is causing the deformation is entrapped by the flexible element if two reflections of the ultrasonic pulse are received with different propagation times. In particular, a first reflection of the two reflections can be received with the reference propagation time, and a second reflection of the two reflections can be received with a propagation time that is shorter than the reference propagation time. The occurrence of two reflections from the same emitted ultrasonic pulse may indicate that a part of the ultrasonic pulse is reflected by a deformed area of the flexible element, but that, nevertheless, a part of the ultrasonic pulse is still reaching the reflector. This is indicative of a partial deformation of the flexible element.

Preferably, the processor module is set up to carry out a calibration of the device. In particular, self-calibration may be carried out. To this end, the ultrasonic transmitter can emit an initial ultrasonic pulse. If the response received at the ultrasonic detector is within a predefined expectation window, the device can be activated, or armed, and emit ultrasonic pulses to monitor for entrapment. Typically, calibration is carried out in situations where there is no deformation or entrapment, e.g., when the doors of the means of transport are completely open and/or while traveling at high speed.

Preferably, the ultrasonic transmitter and the ultrasonic detector are integrated in a functional unit. In particular, the ultrasonic transmitter and the ultrasonic detector can be realized in a common hardware module. The integration enables simple exchange of the hardware module with little effort.

Preferably, the ultrasonic transmitter and the ultrasonic detector form a transmitting and receiving unit. In particular, the ultrasonic transmitter and the ultrasonic detector can be included in a transducer, or form a transducer.

Preferably, the hollow space of the flexible element has a first section, and a second section located opposite to the first section. The ultrasonic transmitter and the ultrasonic detector can be arranged in or at the first section, i.e., the same section of the hollow space. The single-side installation reduces the installation costs.

Preferably, the reflector is arranged in or at the second section. In particular, the reflector can be located opposite to the ultrasonic transmitter and the ultrasonic detector, so that the ultrasonic transmitter emits the ultrasonic pulses in the direction of the reflector, and the reflector reflects the ultrasonic pulses in the direction of the ultrasonic detector.

Preferably, the first section is a first end and/or a first opening of the hollow space. In addition, or alternatively, the second section is a second end and/or a second opening of the hollow space.

Preferably, the ultrasonic transmitter, and the ultrasonic detector (and, optionally, the processor module) are integrated in a first closing element that closes the first end and/or the first opening of the hollow space. The first closing element can, e.g., be a cap or a plug.

Preferably, the reflector (and, optionally, the processor module) is integrated in a second closing element that closes the second end and/or the second opening of the hollow space. The second closing element can, e.g., be a cap or a plug.

Preferably, the hollow space has an oblong shape. The oblong shape can have a longitudinal extension or a longitudinal axis. In some embodiments, the first section with the ultrasonic transmitter and the ultrasonic detector, and the second section with the reflector can be arranged along the longitudinal axis, and at a (maximal) distance from one another.

Preferably, the hollow space has a round cross-section in an undeformed condition. In particular, the hollow space can have a cylindrical shape. However, this disclosure is not limited to this, and other cross-section geometries may be used.

Preferably, the hollow space is filled with air. In air, the ultrasound can be transmitted inside the hollow space in a defined manner.

Preferably, an inner wall of the hollow space is coated with a reflecting material.

Preferably, the flexible element is made of plastic, in particular of rubber, e.g., black rubber.

Preferably, the flexible element is a profiled element, in particular a rubber profile. The profile may have one or multiple projections and/or one or multiple air chambers and/or one or multiple profiled lips that form a flexible contact area.

In addition, or alternatively, the flexible element can be a seal. The seal may have one or multiple projections and/or one or multiple air chambers and/or one or multiple profiled lips that form a flexible contact area.

Preferably, the flexible element is a profiled safety strip, in particular for a door of a means of transport.

According to a further independent aspect of this disclosure, a door for a means of transport, having a device for the detection of an entrapment situation at a means of transport according to the embodiments of this disclosure, is specified.

According to a further independent aspect of this disclosure, a means of transport is specified. The means of transport comprises the device for the detection of an entrapment situation at a means of transport and/or the door according to the embodiments of this disclosure.

The term means of transport includes commercial vehicles (e.g., buses), railroad vehicles, elevators, airplanes, and ropeway cabins, etc., used for the purpose of transporting persons, goods, etc.

According to a further independent aspect of this disclosure, a method for the detection of an entrapment situation at a means of transport is specified. The method comprises an emission, by an ultrasonic transmitter, of ultrasonic pulses into a hollow space of a flexible element in the direction of a reflector; a reception, by an ultrasonic detector, of ultrasound reflected within the hollow space and/or at the reflector, and an output of an appropriate detection signal; and a determination, based on the detection signal, of whether there is a deformation of the flexible element which indicates that the flexible element entraps an object which is causing the deformation.

The method may implement the aspects of the device for the detection of an entrapment situation at a means of transport described herein.

According to a further independent aspect of this disclosure, a software (SW) program is specified. The SW program can be set up to be executed on one or multiple processors, and to implement, in this way, the method for the detection of an entrapment situation at a means of transport described herein.

According to a further independent aspect of this disclosure, a storage medium is specified. The storage medium may comprise a SW program that is set up to be executed on one or multiple processors, and to implement, in this way, the method for the detection of an entrapment situation at a means of transport described herein.

According to a further independent aspect of this disclosure, a software with program code is to be executed for the carrying out of the method for the detection of an entrapment situation at a means of transport if the software is running on one or multiple software-controlled devices.

According to a further independent aspect of this disclosure, a system for the detection of an entrapment situation at a means of transport is specified. The system comprises one processor or multiple processors, and at least one memory that is connected to the one processor or the multiple processors, and contains instructions that can be executed by the one processor or the multiple processors to carry out the method for the detection of an entrapment situation at a means of transport described herein.

A processor, or a processor module is a programmable arithmetic unit, i.e., a machine, or an electronic circuit, which, in accordance with commands handed over to it, controls other elements and thereby drives an algorithm (process).

### BRIEF DESCRIPTION OF THE DRAWINGS

Embodiments of the disclosure are shown in the figures, and are described in more detail below.

FIG. 1 is a schematic diagram of a device for the detection of an entrapment situation at a means of transport according to embodiments of this disclosure;

FIG. 2 is a schematic diagram of a device for the detection of an entrapment situation at a means of transport according to further embodiments of this disclosure;

FIG. 3 is a schematic diagram of a device for the detection of an entrapment situation at a means of transport according to further embodiments of this disclosure;

FIG. 4 is a schematic diagram of a signal processing in a device for the detection of an entrapment situation at a means of transport according to embodiments of this disclosure;

FIG. 5 is a schematic diagram of ultrasonic pulses and reflections according to embodiments of this disclosure;

FIGS. 6A and 6B are schematic diagrams of ultrasonic pulses and reflections according to further embodiments of this disclosure;

FIG. 7 is a schematic diagram of ultrasonic pulses and reflections according to further embodiments of this disclosure; and

FIG. 8 is a flow chart of a method for the detection of an entrapment situation at a means of transport according to embodiments of this disclosure.

### DETAILED DESCRIPTION OF THE INVENTION

Unless otherwise indicated, identical reference numerals/letters are used in the following for identical and identical-effect elements.

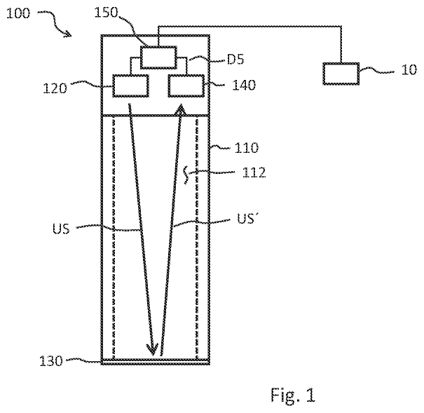

FIG. 1 shows a schematic diagram of a device 100 for the detection of an entrapment situation at a means of transport according to embodiments of this disclosure.

The device 100 comprises a flexible element 110 that encompasses a hollow space 112; an ultrasonic transmitter 120 that is arranged at or inside the hollow space 112, the ultrasonic transmitter 120 being set up to emit ultrasound US into the hollow space 112; a reflector 130 that is arranged at or inside the hollow space 112, the reflector 130 being set up to reflect ultrasound US; an ultrasonic detector 140 that is arranged at or inside the hollow space 112, the ultrasonic detector 140 being set up to detect the ultrasound US' emitted by the ultrasonic transmitter 120 and reflected in the device 100, and to generate a detection signal DS; and a processor module 150 that is set up to determine, based on the detection signal DS of the ultrasonic detector 140, whether there is a deformation of the flexible element 110 which indicates that the flexible element 110 entraps an object which is causing the deformation.

The reflector 130 serves as reference, i.e., if the ultrasound passes through the hollow space 112 without hindrance, and is reflected by the reflector 130 back to the ultrasound detector 140, then, as shown in FIG. 1, there is no deformation of the flexible element 110, and hence no entrapment of an object. If there is a deformation of the flexible element 110, the deformation impedes the undisturbed propagation of the ultrasound, and changes the detection signal DS at the ultrasonic detector 140. In other words, the ultrasound received at the ultrasonic detector 140 does not correspond to the reference. In dependence on a propagation time and/or an amplitude of the reflection(s) received at the ultrasonic detector 140, it can then be determined how great the deformation is and/or whether an object is entrapped by the flexible element 110.

Typically, the ultrasonic transmitter 120 is set up to emit ultrasonic pulses as the ultrasound US. Each emitted ultrasonic pulse has a pulse width, and an amplitude which can be chosen appropriately in dependence on the device 100 and/or an area of application of the device 100.

In some embodiments, the flexible element 110 can be a profiled safety strip for a door of a means of transport, such as a bus, or a railroad vehicle. If, due to the deformation of the flexible element 110, the device 100 according to the invention detects that, e.g., a thing or a person, is entrapped by doors that are closing, the device 100 can initiate appropriate countermeasures. For example, the device 100 can output information with respect to the detected entrapment to a door control unit 10 that stops the closing of the doors, and reopens the doors.

The processor module 150 can be set up to control the ultrasonic transmitter 120, and to evaluate the detection signal DS received from the ultrasonic detector 140. Typically, the processor module 150 is a microcontroller unit (MCU).

Preferably, the processor module 150 is set up to carry out a calibration of the device 100. To this end, the ultrasonic transmitter 120 can emit an initial ultrasonic pulse. If the response received at the ultrasonic detector 140 is within a predefined expectation window, the device 100 can be activated, or armed, and emit ultrasonic pulses to monitor for entrapment. Typically, calibration is carried out in situations where there is no deformation or entrapment, e.g., when the doors of the means of transport are completely open and/or while traveling at high speed.

Furthermore, processor module 150 can be set up to monitor the ultrasonic transmitter 120 and/or the ultrasonic detector 140. For example, a response at the ultrasonic detector 140 within a specific time window can be expected only if an ultrasonic pulse has been emitted by the ultrasonic transmitter 120. This allows efficient operation of the device 100.

In addition, or alternatively, the device 100, in particular the processor module 150, can comprise a watchdog function, i.e., a function test of the processor module 150 and/or the ultrasonic transmitter 120 and/or the ultrasonic detector 140 can be carried out at regular intervals. If an error is detected, the processor module 150 can output, or instruct, a safe condition. For example, the door control unit 10 can be instructed to enter into a safe condition (e.g., not to open doors, or only allow manual closing of the doors, e.g., by a bus driver).

In some embodiments, the processor module 150 can be set up to control the ultrasonic transmitter 120 in such a way that the ultrasonic transmitter 120 emits the ultrasound US in dependence on a situation. For example, the ultrasound US can be emitted in dependence on an operating state of the means of transport and/or a state of motion of the means of transport. In particular, the ultrasound US may be emitted only while there is the danger of an object being entrapped by the flexible element 110. In this way, the device 100 can be operated energy-efficiently, and a service life of the device 100 can be extended.

An example of an operating state in which the ultrasound US is emitted is during the closing of a door of the means of transport. An example of a state of motion of the means of transport during which the ultrasound US is emitted is during a standstill, or a slow driving of the means of transport. For example, the means of transport, in particular the device, can comprise an acceleration sensor and/or a speed sensor that controls an activation, and deactivation of the ultrasound monitoring. For example, the ultrasound monitoring may be activated only while the means of transport is standing still, or is moving at a speed of less than, e.g., 5 km/h, or 10 km/h.

In some embodiments, a calibration, or self-calibration of the device 100 can be carried out during the slow driving. For example, the time until standstill can be sufficient to complete the calibration of the device 100, and to start the ultrasound monitoring.

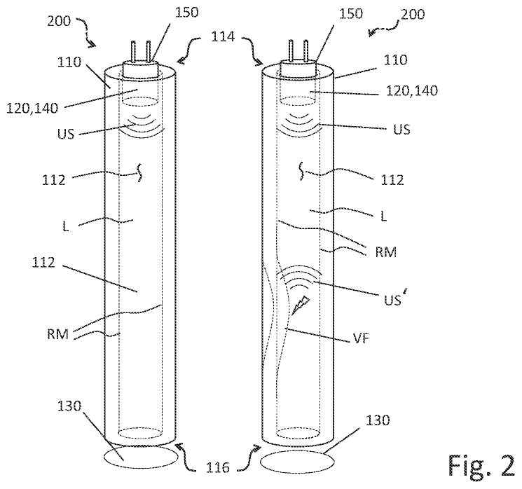

FIG. 2 shows a schematic diagram of a device 200 for the detection of an entrapment situation at a means of transport according to further embodiments of this disclosure. On the left side in FIG. 2, a condition without deformation is shown, and on the right side in FIG. 2, a condition with a deformation DF is shown.

Without deformation, the ultrasound US emitted by the ultrasonic transmitter 120 passes through the hollow space 112 without hindrance, and is reflected by the reflector 130 back to the ultrasound detector 140. If there is a deformation DF of the flexible element 110, the deformation DF impedes the undisturbed propagation of the ultrasound, or reflects at least part of the ultrasound US emitted by the ultrasonic transmitter 120, and in this way changes the detection signal DS at the ultrasonic detector 140.

The deformation DF can be a cross-section constriction of the hollow space 112.

In case of a slight deformation DF of the flexible element 110, the ultrasound US emitted by the ultrasonic transmitter 120 can be reflected partly by the deformation DF, and partly by the reflector. Accordingly, the ultrasonic detector 140 receives a reflection from the deformation DF, and a reflection from the reflector 130. By contrast, in case of a large deformation DF, the ultrasound US emitted by the ultrasonic transmitter 120 can be reflected essentially completely by the deformation DF. In other words, the ultrasound US emitted by the ultrasonic transmitter 120 does not reach the reflector 130, and the ultrasonic detector 140 hence only receives a reflection from the deformation DF, and no reflection from the reflector 130.

In some embodiments, the ultrasonic transmitter 120, and the ultrasonic detector 140 can be integrated in a functional unit. In particular, the ultrasonic transmitter 120 and the ultrasonic detector 140 can be included in a transducer, or form a transducer.

In exemplary embodiments, the hollow space 112 of the flexible element 110 can have a first section 114, and a second section 116 located opposite to the first section 114. The first section 114 can be a first end and/or a first opening of the hollow space 112, and the second section 116 can be a second end and/or a second opening of the hollow space 112.

The ultrasonic transmitter 120 and the ultrasonic detector 140, in particular the transducer, can be arranged in or at the first section 114 (e.g., in or at the first opening). The reflector 130 can be arranged in or at the second section 116 (e.g., in or at the second opening). In particular, the reflector 130 can be arranged opposite to the ultrasonic transmitter 120 and the ultrasonic detector 140, in particular the transducer, so that the ultrasonic transmitter 120 emits the ultrasound US, or the ultrasonic pulses in the direction of the reflector 130, and the reflector 130 reflects the ultrasound US, or the ultrasonic pulses back in the direction of the ultrasonic detector 140.

In some embodiments, the ultrasonic transmitter 120, and the ultrasonic detector 140 (and, optionally, the processor module) can be integrated in a first closing element 150 that closes the first end and/or the first opening of the hollow space 112. The first closing element 150 can, e.g., be a cap or a plug.

In addition, or alternatively, the reflector 130 (and, optionally, the processor module) can be integrated in a second closing element (not shown) that closes the second end and/or the second opening of the hollow space 112. The second closing element can, e.g., be a cap or a plug.

In some embodiments, the hollow space 112 can have an oblong shape with a longitudinal extension or a longitudinal axis. The first section 112 with the ultrasonic transmitter 120 and the ultrasonic detector 140, in particular the transducer, and the second section 116 with the reflector 130 can be arranged along the longitudinal axis, and at a distance from one another.

Preferably, the hollow space 112 has a round cross-section in an undeformed condition. The cross-section is defined in a plane perpendicular to the longitudinal extension or the longitudinal axis. For example, the hollow space 112 can have a cylindrical shape. In some embodiments, the hollow space 112 can be filled with air A.

In some embodiments, an inner wall of the hollow space 112 can be coated with a reflecting material RM. The coating with the reflecting material RM can enable an improved reflection of the ultrasound, e.g., at a deformation.

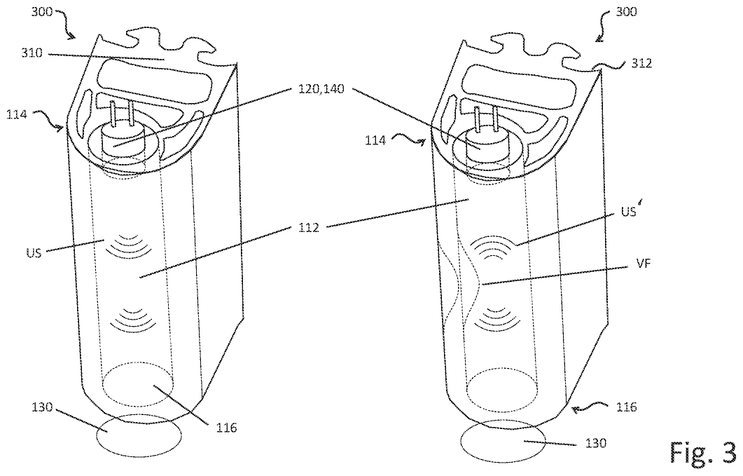

FIG. 3 shows a schematic diagram of a device 300 for the detection of an entrapment situation at a means of transport according to further embodiments of this disclosure.

In some embodiments, the flexible element 312 can be a profiled element, in particular a rubber profile. The profile may have one or multiple projections and/or one or multiple air chambers and/or one or multiple profiled lips that form a flexible contact area. The flexible element 312 can be, e.g., a profiled safety strip, in particular for a door of a means of transport.

According to some embodiments, which can be combined with other embodiments described here, the flexible element 312 is made of plastic, in particular rubber, e.g., black rubber.

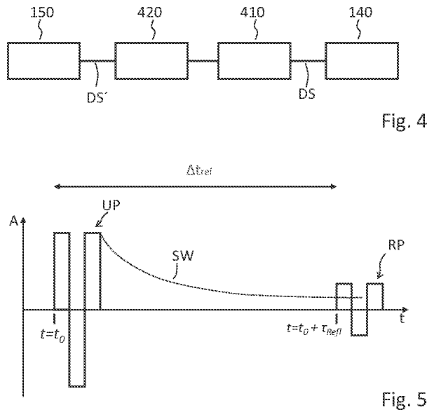

FIG. 4 shows a schematic diagram of a signal processing in a device for the detection of an entrapment situation at a means of transport according to embodiments of this disclosure.

The ultrasonic detector 140 detects the reflected ultrasound, and outputs a detection signal DS. The detection signal DS can be processed further by at least one signal processing module 410, 420 to generate a detection signal DS' which is then output to the processor module 150 for evaluation.

In some embodiments, the at least one signal processing module can comprise an amplifier 410 that receives, and amplifies the detection signal DS of the ultrasonic detector 140. In addition to an amplification, the amplifier 410 can also have filtering properties, and intentional nonlinearities, such as an amplitude limitation, to condition the detection signal DS for subsequent modules.

In some embodiments, the at least one signal processing module can comprise an analog-to-digital converter 420 that receives the detection signal amplified by the amplifier 410. The analog-to-digital converter 420 can be provided as a separate module, as shown in FIG. 4. Alternatively, the analog-to-digital converter 420 can be integrated in the processor module 150.

As an alternative to the analog-to-digital converter, the at least one signal processing module can comprise a comparator 420 that receives the detection signal amplified by the amplifier 410. The comparator 420 can be provided as a separate module, as shown in FIG. 4. Alternatively, the comparator 420 can be integrated in the processor module 150.

FIG. 5 shows a schematic diagram of ultrasonic pulses and reflections according to embodiments of this disclosure.

Typically, the ultrasonic transmitter is set up to emit ultrasonic pulses UP as the ultrasound. Each emitted ultrasonic pulse UP has a pulse width, and an amplitude A in relation to the time axis t.

Deformations of the flexible element, e.g., cross-section constrictions, can be detected based on a propagation time of the reflected ultrasonic pulses RP received at the ultrasonic detector. In general, the propagation time is defined as a period of time between the emission of the ultrasonic pulse UP by the ultrasonic transmitter at t=t₀, and the reception of the reflected ultrasonic pulse RP by the ultrasonic detector at t=t₀+τ_{Ref1}. A propagation time between the ultrasonic transmitter, and the ultrasonic detector, of a reflected ultrasonic pulse RP reflected at the reflector can be defined as reference, or as reference propagation time Δtref (e.g., determined during a calibration). In other words, the reflector may provide a reference based on which deformations can be detected.

In particular, the ultrasonic pulses UP emitted into the hollow space of the flexible element by the ultrasonic transmitter can be reflected in dependence on deformations at different locations in the hollow space, which results in different propagation times which, in turn, give information about the deformation of the flexible element. For example, a deformation can be detected if the propagation time of a reflected ultrasonic pulse RP received at the ultrasonic detector is shorter than the reference propagation time Δtref.

Optionally, deformations of the flexible element, e.g., cross-section constrictions, can be detected also based on an amplitude of the reflected ultrasonic pulses RP received at the ultrasonic detector. For example, a deformation can be detected if the amplitude of the reflection RP of the ultrasonic pulse UP received at the ultrasonic detector with the reference propagation time Δtref is smaller than a reference amplitude (e.g., determined during a calibration). The reference amplitude may correspond to an amplitude that occurs if there is no deformation of the flexible element, and the ultrasonic pulse UP reaches the reflector without hindrance. If the amplitude of the pulse RP with the reference propagation time Δtref is smaller than the reference amplitude, this may indicate that a part of the ultrasonic pulse UP was reflected by a deformed area of the flexible element, but that, nevertheless, a part of the ultrasonic pulse UP is still reaching the reflector. This is indicative of a partial deformation of the flexible element.

In some embodiments, a degree of the deformation of the flexible element can be determined based on a deviation of the amplitude of the reflection RP from the reference amplitude. If the deviation is small, the deformation is slight, because a large part of the ultrasonic pulse UP is reaching the reflector. If, however, the deviation is large, the deformation is large, because only a small part (or no part at all) of the ultrasonic pulse UP is reaching the reflector. In the borderline case, no ultrasound can reach the reflector at maximal deformation, so that no detection signal occurs at the reference propagation time Δtref.

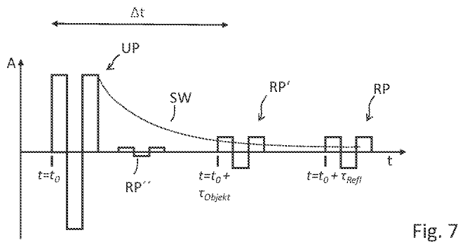

In the example of FIG. 5, a threshold TH is shown, which can vary over the propagation time. As regards the threshold TH, reference is made to the statements regarding FIG. 7.

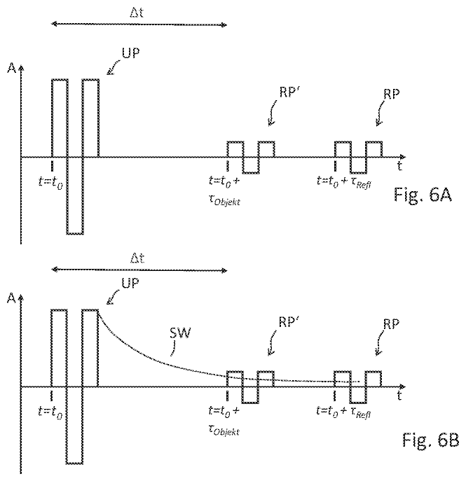

FIGS. 6A and 6B show schematic diagrams of ultrasonic pulses and reflections according to further embodiments of this disclosure. FIG. 6A shows a case without a threshold, and FIG. 6B shows a case with a threshold TH. As regards the threshold TH, reference is made to the statements regarding FIG. 7.

In the examples of FIGS. 6A and 6B, there is a partial deformation of the flexible element, so that a part of the ultrasonic pulse UP is reflected at the reflector, and another part of the ultrasonic pulse UP is reflected at the deformation. The part of the ultrasonic pulse UP reflected at the reflector generates the reflection RP at the reference propagation time. The part of the ultrasonic pulse UP reflected at the deformation generates the reflection RP′ with the propagation time Δt that is shorter than the reference propagation time.

Based on the propagation time and, optionally, the amplitude of the two reflections RP and RP′, it can then be determined that there is a deformation, and an entrapment can be detected.

FIG. 7 shows a schematic diagram of ultrasonic pulses and reflections according to further embodiments of this disclosure. In contrast to the FIGS. 6A and 6B, there is a further reflection RP″ in addition to the two reflections RP and RP′.

In some embodiments, a threshold can be defined that specifies a minimum amplitude for using a reflection for entrapment detection. This in particular concerns reflections with propagation times that are shorter than the reference propagation times Δtref. If the amplitude of a reflection with Δt<Δtref is smaller than the threshold (the further reflection RP″ in FIG. 7), the reflection can be discarded, because, e.g., it can be assumed that the reflection is due to an irrelevant and/or a permanent deformation of the flexible element, e.g., caused by wear, and not due to an entrapment of an object or a person. Moreover, the threshold can be used to reduce an influence of extrusion tolerances in the production of the flexible element.

In the examples of FIGS. 5 through 7, the threshold is a threshold TH which can vary over the propagation time. In particular, the threshold TH can decrease as the propagation time progresses.

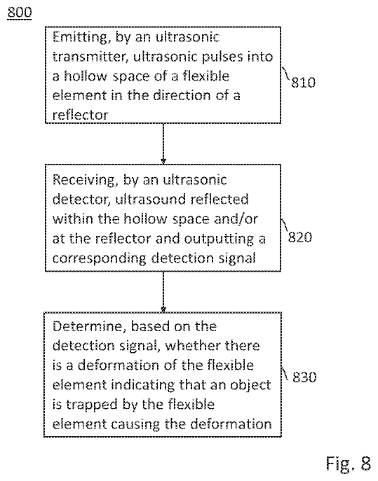

FIG. 8 shows a schematic flow chart of a method 800 for the detection of an entrapment situation at a means of transport according to embodiments of this disclosure. The method 800 can be implemented by means of an appropriate software that can be executed by one or multiple processors (e.g., a CPU).

The method 800 comprises, in block 810, an emission, by an ultrasonic transmitter, of ultrasonic pulses into a hollow space of a flexible element in the direction of a reflector; in block 820, a reception, by an ultrasonic detector, of ultrasound reflected within the hollow space and/or at the reflector, and an output of an appropriate detection signal; and, in block 830, a determination, based on the detection signal, of whether there is a deformation of the flexible element which indicates that the flexible element entraps an object which is causing the deformation.

According to the invention, ultrasound is emitted into the hollow space of the flexible element, reflected there, and detected. Based on the detected reflections of the ultrasound, it is determined whether there is a deformation of the flexible element. To this end, the reflector serves as reference, i.e., if the ultrasound passes through the hollow space without hindrance, and is reflected by the reflector back to the ultrasound detector, then there is no deformation, and hence no entrapment of an object. If the ultrasound received at the ultrasonic detector does not correspond to this reference, it can be determined, e.g., in dependence on a propagation time and/or an amplitude of the reflections received at the ultrasonic detector, how great the deformation is, and whether it can be derived from this that an object is entrapped by the flexible element. The combination of ultrasonic transmitter, reflector, and ultrasonic detector enables reliable and cost-effective entrapment detection.

While the invention has been particularly illustrated and explained in more detail by means of examples of preferred embodiments, the invention is not limited by these disclosed examples, and other variations can be derived by those skilled in the art without departing from the scope of protection of the invention. Therefore, it will be understood that a multitude of variation possibilities exists. Likewise, it will be understood that exemplary embodiments specified herein really are merely examples which cannot be interpreted in any way whatsoever to limit the scope of protection, the possible applications, or the configuration of the invention. Rather, the above description and the description of the figures enable those skilled in the art to specifically implement the exemplary embodiments, those skilled in the art, knowing the disclosed inventive concept, being able to make numerous modifications, e.g., with respect to the function and the arrangement of individual elements mentioned in an exemplary embodiment, without departing from the scope of protection that is defined by the claims and their legal equivalents, such as further explanations in the description.

1. A device for the detection of an entrapment situation by a means of transport, comprising:
a flexible element that encompasses a hollow space;
an ultrasonic transmitter that is arranged at or inside the hollow space, the ultrasonic transmitter configured to emit ultrasound into the hollow space;
a reflector arranged at or inside the hollow space, the reflector configured to reflect ultrasound;
an ultrasonic detector arranged at or inside the hollow space, the ultrasonic detector configured to detect the ultrasound emitted by the ultrasonic transmitter and reflected in the device, and to generate a detection signal; and
a processor module configured to determine, based on the detection signal of the ultrasonic detector, whether there is a deformation of the flexible element which indicates that the flexible element entraps an object which is causing the deformation.

2. The device according to claim 1, wherein the ultrasonic transmitter is configured to emit ultrasonic pulses.

3. The device according to claim 1, wherein the ultrasonic transmitter is configured to:
emit the ultrasonic pulses at predefined time intervals; and/or
emit the ultrasonic pulses in dependence on a situation, in particular based on a movement of the means of transport.

4. The device according to claim 2, where the processor module is configured to determine, based on a propagation time and/or an amplitude of the ultrasonic pulses reflected in the device, and received at the ultrasonic detector, whether the deformation of the flexible element is present.

5. The device according to claim 4, where the processor module is configured to determine that the flexible element entraps an object which is causing the deformation if:
the propagation time of a reflection of an ultrasonic pulse received at the ultrasonic detector is shorter than a reference propagation time, where, in particular the reference propagation time corresponds to a propagation time between the ultrasonic transmitter, and the ultrasonic detector, of a reflected ultrasonic pulse reflected at the reflector; and/or
the amplitude of the reflection of the ultrasonic pulse received at the ultrasonic detector with the reference propagation time is smaller than a reference amplitude; and/or
two reflections of the ultrasonic pulse are received with different propagation times.

6. The device according to claim 1, wherein the processor module is configured to carry out a calibration of the device, in particular during a standstill of the means of transport and/or a slow driving of the means of transport.

7. The device according to claim 1, wherein:
the ultrasonic transmitter, and the ultrasonic detector are integrated in a functional unit; and/or
the ultrasonic transmitter, and the ultrasonic detector form a transmitting and receiving unit; and/or
the ultrasonic transmitter, and the ultrasonic detector are included in a transducer, or form a transducer.

8. The device according to claim 1, wherein:
the hollow space has a first section, and a second section located opposite to the first section;
the ultrasonic transmitter, and the ultrasonic detector are arranged in or at the first section;
the reflector is arranged in or at the second section;
in particular, the first section is a first end and/or a first opening of the hollow space and/or the second section is a second end and/or a second opening of the hollow space.

9. The device according to claim 1, wherein:
the hollow space has an oblong shape; and/or
the hollow space has a round cross-section; and/or
the hollow space has a cylindrical shape; and/or
the hollow space is filled with air; and/or
an inner wall of the hollow space is coated with a reflecting material.

10. The device according to claim 1, wherein:
the flexible element is made of plastic, in particular of rubber; and/or
the flexible element is a profiled element, in particular a rubber profile; and/or
the flexible element is a seal.

11. The device according to claim 1, wherein the flexible element is a profiled safety strip, in particular for a door of a means of transport.

12. A door for a means of transport, comprising the device according to claim 1.

13. A means of transport, comprising the door according to claim 12.

14. A method for the detection of an entrapment situation by a means of transport, comprising:
emission, by an ultrasonic transmitter, of ultrasonic pulses into a hollow space of a flexible element in a direction of a reflector;
reception, by an ultrasonic detector, of ultrasound reflected within the hollow space and/or at the reflector, and output of an appropriate detection signal; and
determination, based on the detection signal, of whether there is a deformation of the flexible element which indicates that the flexible element entraps an object which is causing the deformation.

15. A storage medium, comprising a software program that is configured to be executed on one or multiple processors, and to implement, in this way, the method according to claim 14.
